(19) United States
(12) Patent Application Publication
(10) Pub. No.: US 2009/0307015 A1
(43) Pub. Date: Dec. 10, 2009

(54) SYSTEM AND METHOD OF MANAGING AN INSURANCE SCHEME

(75) Inventors: Adrian GORE, Houghton Estate (ZA); Herschel Phillip MAYERS, Johannesburg (ZA); Kenneth Steven RABSON, Johannesburg (ZA)

Correspondence Address: PAUL D. BIANCO;Fleit Gibbons Gutman Bongini & Bianco PL, 21355 EAST DIXIE HIGHWAY, SUITE 115, MIAMI, FL, 33180, US

(73) Assignee: DISCOVERY HOLDINGS LIMITED, Sandton (ZA)

(21) Appl. No.: 12/477,225

(22) Filed: Jun. 3, 2009

(30) Foreign Application Priority Data
Jun. 3, 2008 (ZA) 2008/04808

(51) Int. Cl. G06Q 40/00

(52) U.S. Cl. 705/4

(57) ABSTRACT

A system for managing an insurance scheme includes an event module for defining at least one insured event for an insured person. A calculation module calculates at least one benefit to be paid out on the occurrence of the at least one insured event wherein the amount of the at least one benefit is adjusted depending on the number of dependents of the insured person. Finally, an awards module, on the occurrence of the at least one insured event, provides the calculated at least one benefit to the insured person.

### BACKGROUND OF THE INVENTION

The present application relates to a system and method of managing an insurance scheme.

The present invention may be implemented by a traditional life insurance plan operator for its members or may be implemented by another party.

Conventionally, insurance policies such as life insurance policies operate on the basis that an insured person, sometimes referred to as an insured life, pays a premium to the life insurer, and the life insurer pays a predetermined sum, referred to as the sum assured, to the insured life or his/her beneficiary on the occurrence of an insured event. Typical insured events are the insured life suffering disability, contracting a dread disease or dying.

However, current illness or disability related payments only generically allow for the impact of an illness or disability, for example, without taking into account the specific impact of that illness or disability on the specific insured person.

The present invention allows the financial impact of a specific illness or disability, for example, on a specific individual to be estimated and then to be used to modify the amount of claim paid.

The present invention provides a system and method of addressing this.

### SUMMARY OF THE INVENTION

According to one example embodiment, a system for managing an insurance scheme includes:
an event module for defining at least one insured event for an insured person;
a calculation module for calculating at least one benefit to be paid out on the occurrence of the at least one insured event wherein the amount of the at least one benefit is adjusted depending on the number of dependents of the insured person; and
an awards module for, on the occurrence of the at least one insured event, providing the calculated at least one benefit to the insured person.

The event module may define the plurality of insured events to include at least one of disability, contracting a dread disease or dying.

The calculation module may further calculate the amount of the at least one benefit using a plurality of factors including a life impact of the insured event on the insured person.

In one example, the calculation module further calculates the amount the life impact of the insured event and allocates a score to this.

The calculation module may break down the life impact into one or more of the following criteria, for example: duration of impact; invasiveness of surgery; pharmacological; therapy or rehabilitation required; chemotherapy or radiotherapy; and assisted devices required or care required and allocates a points value to each criteria, the calculation module then sums the points values allocated to determine a total life impact points value which total life impact points value is used as the indicator of the life impact of the insured event to the insured person.

In one embodiment, the calculation module calculates the at least one benefit dependent on the total life impact points value and then uses the number of dependents to alter this calculated at least one benefit.

For example, the calculation module first calculates the at least one benefit and then uses the number of dependents to determine a percentage by which to multiply the at least one benefit to arrive at a revised at least one benefit value that will be awarded by the awards module.

In another embodiment, the calculation module allocate a points value to the number of dependents and adds this points value to the total life impact points calculated to give a higher total points value which is then used by the calculation module to adjust the at least one benefit that will be awarded by the awards module.

The calculation module may access a memory and store the calculated at least one benefit amount therein.

According to one example embodiment, apparatus for managing an insurance scheme includes:
means for defining at least one insured event for an insured person;
means for calculating at least one benefit to be paid out on the occurrence of the at least one insured event wherein the amount of the at least one benefit is adjusted depending on the number of dependents of the insured person; and
means for, on the occurrence of the at least one insured event, providing the calculated at least one benefit to the insured person.

### BRIEF DESCRIPTION OF THE DRAWINGS

FIG. 1 is a flow chart illustrating the methodology of an example embodiment;

FIG. 2 is a block diagram illustrating an example system to implement the methodologies described herein; and

FIG. 3 is a block diagram illustrating an example of one operating environment of the system in FIG. 2

### DESCRIPTION OF EMBODIMENTS

The systems and methodology described herein relate to a system and method of managing an insurance scheme such as a life insurance scheme to name one example.

Conventional life insurance schemes operate on the basis that an insured person, referred to as the insured life, pays premiums on a regular basis to the life insurer, specifying a sum assured which is an amount to be paid out on the occurrence of an insured event. For example, on the death of the insured life, a predetermined death benefit is paid to the nominated beneficiaries of the insured life. If the insured life is disabled or suffers a dread disease, a different, lesser amount is paid out.

The method and system will be described with reference to these kinds of schemes but it will be appreciated that the method and system could equally be applied to other types of insurance schemes.

It will also be appreciated that the system and methodology may be implemented by any relevant person or organisation. For example, the system and methodology may be operated by the organisation which operates the life insurance scheme or may be implemented by another associated organisation. In one example the system and methodology may be implemented by a financial organisation which issues credit cards to its members.

For purposes of illustration only, the system and methodology will be described herein as being operated by the managers of a life insurance scheme.

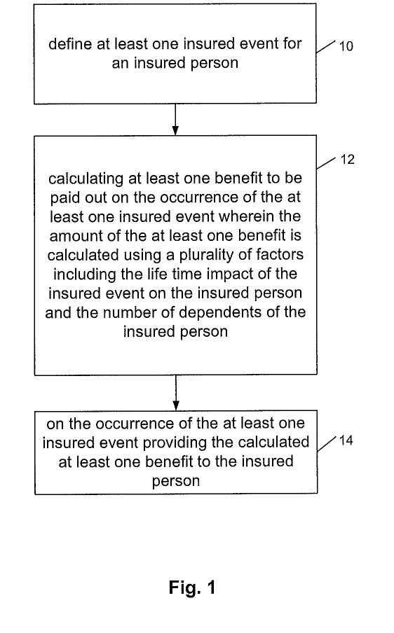

Referring to FIG. 1, a method of managing an insurance scheme includes defining at least one insured event for an insured person (block 10). The at least one insured event may include being injured or suffering a disease for example. The injury may be a temporary injury or a permanent injury for example. The disease may be a so called dread disease for example.

It will be appreciated that the number of insured events defined could be numerous and varied and certainly not limited to the above examples.

At least one benefit to be paid out on the occurrence of the at least one insured event is calculated (block 12).

The amount of the at least one benefit is calculated using a plurality of factors including number of dependents of the insured person.

In one example embodiment, a life impact of the insured event is used to determine the at least one benefit.

This life impact in one example is calculated using one or more of the following criteria: duration of impact; invasiveness of surgery; pharmacological; therapy or rehabilitation required; chemotherapy or radiotherapy; and assisted devices required or care required.

In one example, a point value is assigned to each criteria and then the sum of the point values is calculated to determine a total points value. The total points value is used to determine the life impact of the insured event.

In an example embodiment the criteria are allocated points to arrive at a total points score of between 0 and 15.

| Disease | 1 | 2 | 3 | 4 | 5 | 6 |
|---|---|---|---|---|---|---|
| AIDS | 2 | 0 | 3 | 0 | 0 | 2 |
| Hodgkins Cancer | 6 | 0 | 0 | 0 | 3 | 0 |
| Otosclerosis | 4 | 1 | 0 | 0 | 0 | 1 |
| Atrial fibrillation | 8 | 0 | 1 | 1 | 0 | 0 |

Where the criteria in the table are:

1—duration of impact;
2—invasiveness of surgery
3—pharmacological;
4—therapy or rehabilitation required;
5—chemotherapy or radiotherapy; and
6—assisted devices required or care required.

Thus the higher the total points value the larger the life impact of the insured event.

In another example, the total points value is compared with bands of total points values where each of the bands is assigned a life impact status and in this way the life impact is assessed. Thus, for example:

| LifeTime Impact | Score |
|---|---|
| None to Low | 0-5 |
| Medium | 6-8 |
| Medium to High | 9-12 |
| Very High | 13-15 |

The method may further include calculating the amount of the at least one benefit as relatively higher if the number of dependents of the insured person is higher. For example,

| | LifeTime Impact | | | |
|---|---|---|---|---|
| Number of | | | Medium to | |
| Dependants | None to Low | Medium | High | Very High |
| 0 | 100% | 115% | 125% | 130% |
| 1 | 120% | 130% | 135% | 140% |
| 2 | 130% | 140% | 145% | 160% |
| 3 | 140% | 150% | 160% | 180% |
| More than 3 | 145% | 160% | 180% | 200% |

Alternatively, the number of dependents can be used as one of the criteria accumulating to the total score. In this example the number of dependents could add the following points to the total number of points, for example:

0-1
1-2
3-4
4-5

Using this methodology the total score will be higher and an example table of scores could be as follows:

| Total LifeTime | LifeTime Impact | |
|---|---|---|
| Impact score | category | Payout* |
| 0-4 | 1 | 100% |
| 5-8 | 2 | 115% |
| 9-11 | 3 | 125% |
| 12-13 | 4 | 135% |
| 14-15 | 5 | 145% |
| 16 | 6 | 155% |
| 17 | 7 | 175% |
| 18+ | 8 | 200% |

On the occurrence of the at least one insured event the calculated at least one benefit is provided to the insured person.

An example of applying the first table above is as follows. Consider an insured person being a 40 year old male who is a non-smoker with four dependants. In a prior art scenario the insured person has a life insurance of R1 million and a severe illness benefit of R1 million.

Under such a prior art insurance plan the insured life will be paid out the following on the occurrence of the following insured events:

### Claims: Scenario 1:

Cancer Stage IV−Severity A=R1 million

### Claims: Scenario 2:

Paraplegia−Severity A=R1 million

In terms of the present invention the life impact assessment for cancer stage IV is:

Duration of the impact of the illness on one's lifetime—medium;
Duration for which ongoing treatment, care and devices are needed—medium; and
Overall life impact—medium.

Using the above example table for the present invention, the calculated benefit is 160% being R1.6 million.

In the other example, paraplegia is determined as having a very high life impact.

Using the above example table, the calculated benefit is 200% being R2 million.

Thus it will be appreciated that the unique circumstances of the individual are taken into account as well as the impact of the specific disease or disability, for example, on the specific insured individual.

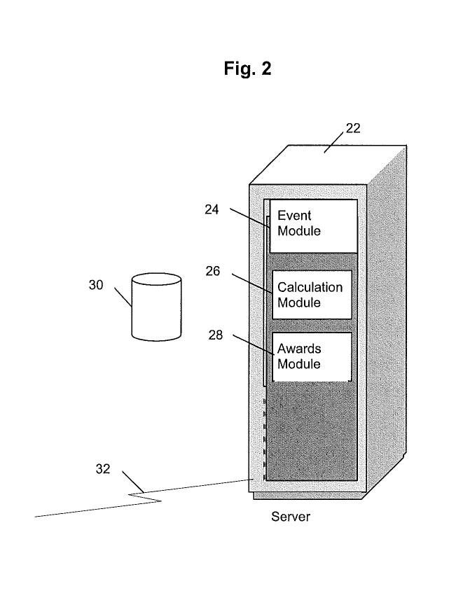

FIG. 2 illustrates an exemplary system for implementing the above methodologies.

A server 22 includes a number of modules to implement the methodologies described above.

An event module 24 defines a plurality of insured events for an insured person.

The module 24 is constructed to define the plurality of insured events which in one embodiment includes at least one of disability, contracting a dread disease or dying as these are typical of the kind of events which are insured by life insurance schemes. However, it will be appreciated that in other contexts these life changing events may be other events.

Once the event module 24 defines the plurality of life changing events, the module 24 accesses a memory and stores the defined plurality of categories of expenses in the memory.

A calculation module 26 is constructed to calculate at least one benefit to be paid out on the occurrence of the at least one insured event.

The amount of the at least one benefit is calculated by the calculating module using a plurality of factors including the number of dependents of the insured person.

In addition, the calculation module 26 is constructed to use the life impact of the insured event on the insured person together with the number of dependents to calculate the benefit.

In this example embodiment, the calculation module 26 is constructed to calculate a life impact of the insured event and allocate a score to this. The calculation module 26 achieves this by further breaking down the life impact into one or more of the following criteria, for example: duration of impact; invasiveness of surgery; pharmacological; therapy or rehabilitation required; chemotherapy or radiotherapy; and assisted devices required or care required.

In one example, the calculation module 26 allocates a point value to each criteria and then the sum of the point values allocated is calculated by the calculation module 26 to determine a total life impact points value. The total life impact points value is used as the indicator of the life impact of the insured event to the insured person. Thus the higher the total points value the larger the life impact of the insured event. An example of this has been illustrated above.

In one example embodiment, the calculation module 26 is constructed to calculate the benefit dependent on the total life impact points value and then to use the number of dependents to alter this calculated benefit.

In this embodiment, the number of dependents is used to determine a percentage by which to multiply the benefit to arrive at a new benefit value that will be awarded by the awards module 28 as will be described below in more detail.

In another example embodiment, the calculation module 26 is constructed to allocate a points value to the number of dependents and add this points value to the total life impact points calculated as described above. This will give a higher total points value which is then used to adjust the benefit that will be awarded by the awards module 28 as will be described below in more detail.

In any case, the calculation module 26 accesses a memory which may be the database 30 and stores the calculated benefit amount therein.

An awards module 28 is used for, on the occurrence of the at least one insured event, providing the calculated at least one benefit to the insured person.

In one example, the awards module 28 is connected via a communications network, for example communications network 32, to a financial institution which it instructs to pay out a cash amount to the insured person or their nominated beneficiaries.

The system includes at least one associated database 30 for storing data to be used by one or more of the above referenced modules.

In addition, the server is typically connected to a communications network 32 for communications with other computers to implement the methodologies described above.

The modules described above may be implemented by a machine-readable medium embodying instructions which, when executed by a machine, cause the machine to perform any of the methods described above.

In another example embodiment the modules may be implemented using firmware programmed specifically to execute the method described herein.

It will be appreciated that embodiments of the present invention are not limited to such architecture, and could equally well find application in a distributed, or peer-to-peer, architecture system. Thus the modules illustrated could be located on one or more servers operated by one or more institutions.

It will also be appreciated that in any of these cases the modules form a physical apparatus with physical modules specifically for executing the steps of the method described herein.

### Operating Environment

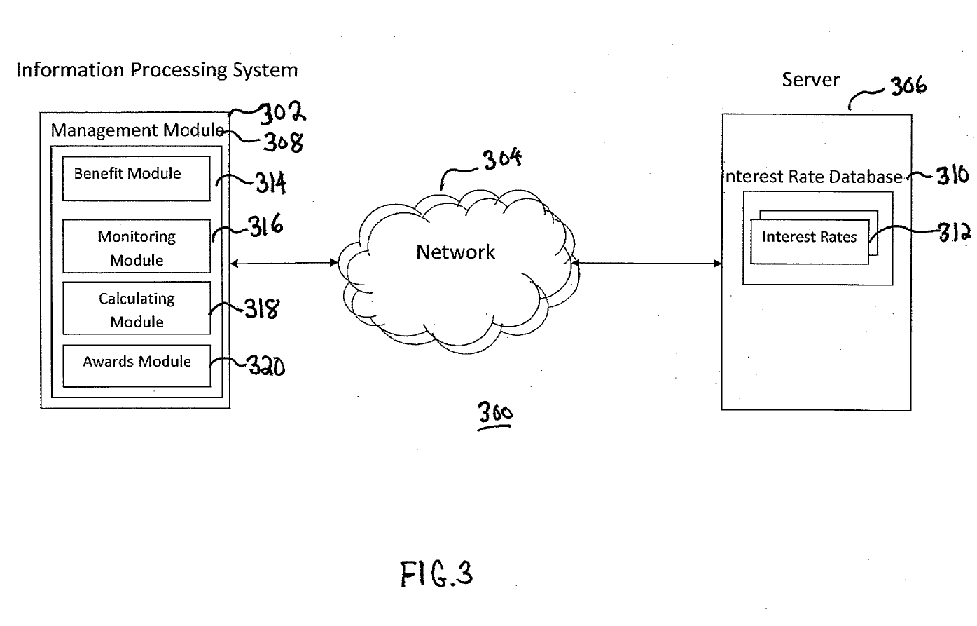

According to one embodiment of the present invention, as shown in FIG. 3, a system and method of 300 for managing an insurance scheme/product is shown. In one embodiment, the system 300 includes one or information processing systems 302 associated with an insurance provider, a network 304, and one or more servers 306. It should be noted that the information processing system 302 is not restricted to being associated with the entity providing insurance to individuals, but can be associated with another entity as well. The insurance provider can provide one or more types of insurance such as a (but not limited to) life insurance scheme to name one example and/or medical insurance to individuals.

The network 304, in one embodiment, is a wide area network, local area network, wireless network, or the like. The information processing system 302 includes a management module 308. The management module 308, in one embodiment, manages an insurance scheme/product. For example, the management module 308, in one example, manages a life insurance product. In this example, the management module 308 manages the benefits of the life insurance product such as a benefit payout by adjusting a monthly benefit payout to an insured person (or beneficiary).

In one embodiment, the server 306 comprises a database 310 including interest rate information 312 that the management module 308 uses to manage the insurance scheme/product. This process was discussed in greater detail above. The management module 308, in one embodiment, includes an events module 314, a calculating module 316, and an awards module 318. It should be noted that although this modules 314, 316, and 318 are shown as residing within the management module 308, one or more of these modules can reside outside of the management module 308 within the system 302 and/or across multiple information processing systems as well.

The operational flows shown in FIG. 1 illustrate one example of managing an insurance product according to one embodiment of the present invention. In particular, FIG. 1 shows a process performed by the management module 308 and its components 314, 316, and 318 within the information processing system(s) 302.

### Non-Limiting Examples

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

Although the various embodiments of the present invention are described in the context of a fully functional computer system, those skilled in the art will appreciate that embodiments are capable of being distributed as a program product via CD or DVD, e.g. CD, CD ROM, or other form of recordable media.

1. A system for managing an insurance scheme, the system including:
an event module for defining at least one insured event for an insured person;
a calculation module for calculating at least one benefit to be paid out on the occurrence of the at least one insured event wherein the amount of the at least one benefit is adjusted depending on the number of dependents of the insured person; and
an awards module for, on the occurrence of the at least one insured event, providing the calculated at least one benefit to the insured person.

2. A system according to claim 1 wherein the event module defines the plurality of insured events to include at least one of disability, contracting a dread disease or dying.

3. A system according to claim 1 wherein the calculation module further calculates the amount of the at least one benefit using a plurality of factors including a life impact of the insured event on the insured person.

4. A system according to claim 3 wherein the calculation module further calculates the amount the life impact of the insured event and allocates a score to this.

5. A system according to claim 3 wherein the calculation module breaks down the life impact into one or more of the following criteria, for example: duration of impact; invasiveness of surgery; pharmacological; therapy or rehabilitation required; chemotherapy or radiotherapy; and assisted devices required or care required and allocates a points value to each criteria, the calculation module then sums the points values allocated to determine a total life impact points value which total life impact points value is used as the indicator of the life impact of the insured event to the insured person.

6. A system according to claim 3 wherein the calculation module calculates the at least one benefit dependent on the total life impact points value and then uses the number of dependents to alter this calculated at least one benefit.

7. A system according to claim 6 wherein the calculation module first calculates the at least one benefit and then uses the number of dependents to determine a percentage by which to multiply the at least one benefit to arrive at a revised at least one benefit value that will be awarded by the awards module.

8. A system according to claim 6 wherein the calculation module allocate a points value to the number of dependents and adds this points value to the total life impact points calculated to give a higher total points value which is then used by the calculation module to adjust the at least one benefit that will be awarded by the awards module.

9. A system according to claim 1 wherein the calculation module accesses a memory and stores the calculated at least one benefit amount therein.

10. Apparatus for managing an insurance scheme, the apparatus including:
means for defining at least one insured event for an insured person;
means for calculating at least one benefit to be paid out on the occurrence of the at least one insured event wherein the amount of the at least one benefit is adjusted depending on the number of dependents of the insured person; and
means for, on the occurrence of the at least one insured event, providing the calculated at least one benefit to the insured person.
